(19) United States
(12) Patent Application Publication
(10) Pub. No.: US 2010/0021015 A1
(43) Pub. Date: Jan. 28, 2010

(54) APPARATUS, AND ASSOCIATED METHOD, FOR APPROVING PASSAGE OF A VEHICLE THROUGH A VEHICULAR CHECKPOINT

(75) Inventor: JAMES BISSETT, SINGAPORE (SG)

Correspondence Address: HEWLETT-PACKARD COMPANY;Intellectual Property Administration, 3404 E. Harmony Road, Mail Stop 35, FORT COLLINS, CO, 80528, US

(73) Assignee: ELECTRONIC DATA SYSTEMS CORPORATION, PLANO, TX (US)

(21) Appl. No.: 12/178,428

(22) Filed: Jul. 23, 2008

(51) Int. Cl. G06K 9/00

(52) U.S. Cl. 382/115

(57) ABSTRACT

An apparatus, and an associated method, for facilitating documentation of the occupants of a vehicle at a border-crossing or other checkpoint. A documentation device is provided through which the occupants of the vehicle self-report documentation information, such as passport information and fingerprint information. Substantiation information is also provided in the form of an infrared or photographic image. If the self-reported documentation information corresponds with the substantiation information, the self-reported information is considered to be valid. If, however, the substantiation information does not correspond with the documentation information, further investigation of the vehicle is warranted.

The present invention relates generally to a manner by which to facilitate clearance of the vehicles at a border-crossing, or other checkpoint. More particularly, the present invention relates to an apparatus, and an associated method, by which to document the occupants of the vehicle, who provide information and an image taken within the vehicle, to verify their identity and number.

A decision is able to be made remotely, based upon the occupant-provided information and image, whether to permit passage of the vehicle through the checkpoint. If a discrepancy is noted between the occupant-provided information and the number of occupants detected in the image, additional inspection is carried out.

### BACKGROUND OF THE INVENTION

Security needs in modern society are many and varied. While security concerns have been essential throughout human history, technological advancements have increased the need for improved security and also have provided increased possibilities of improved security techniques.

Vehicular transportation is also an essential aspect of modern society. For many, vehicular transportation is the primary transportation mechanism of every day life. Vehicles are operated for both daily commuting and longer-distance travels. And, highway, and other roadway systems have been constructed and are traveled by many millions of vehicles every day.

Highway systems and roadways do not end at national borders, but, instead, continue on, or connect with, highway and roadway systems of adjoining areas. At many national borders, border control procedures are effected. And, pursuant to the border control procedures, entry of people crossing the border from one jurisdictional area to another jurisdictional area is regularly controlled. Only those who are authorized to enter into the new jurisdiction are permitted to do so. Others are refused entry.

When vehicular transportation is used to transport people across the national boundary, the border control personnel generally effect border control security by only permitting the vehicle to enter the new jurisdiction if the occupants of the vehicle are documented to be authorized to enter the new jurisdiction. Typically, a checkpoint is constructed at, or very close to, the border. And, when the vehicle reaches the checkpoint, the vehicle is required to stop, and the occupants of the vehicle are required to present documentation as evidence of their authorization to enter the new jurisdiction.

Sometimes, a person is required is present a valid passport or evidence of nationality or citizenship in order to be authorized to enter a new jurisdiction. Sometimes, additionally, a valid visa or additional documentation is further required to be presented in order to be authorized to enter the new jurisdiction. And, sometimes, biometric information, such as fingerprint information, is also required to be provided.

Conventionally, at a border-crossing checkpoint, checkpoint personnel inspect the vehicle and review the documentation of the occupants of the vehicle. If the proper documentation is provided, the personnel of the checkpoint permit the vehicle to continue on into the new jurisdiction. If the documentation is not acceptable, the vehicle is prevented from continuing on into the new jurisdiction.

High-volume, border checkpoints require significant, manpower-resource allocations so that traffic jams to do result. While border-crossing inspection procedures are inherently, manually intensive, requiring human judgment, various aspects of documentation procedures take advantage of technological advancements.

Document readers, for instance, are sometimes utilized to read passport information. And, once read, the passport information is compared with an electronic database to document the passport owner. Electronic scanning of fingerprint information is also available and sometimes used. Fingerprint information is collected and stored, available for comparison with other stored information.

While the use of electronic readers and scanners facilitates authorization of persons at the checkpoint, their conventional use does not obviate the need of personnel to be positioned at each vehicle at the checkpoint. Typically, a larger majority of the vehicular occupants are properly documented and are permitted passage through the checkpoint. And, for vehicles at the checkpoint with these occupants, greater levels of self-reporting of the documentation information would lessen the burden on the checkpoint personnel. However, careful monitoring would continue to be required to ensure that all of the occupants in the vehicles are properly identified and that documentation information is submitted for all of the occupants of the vehicle.

If a manner could be provided by which to facilitate documentation of the occupants of a vehicle at a checkpoint, improved efficiency of operation would result.

It is in light of this background information related to checkpoint security that the significant improvements of the present invention have evolved.

### SUMMARY OF THE INVENTION

The present invention, accordingly, advantageously provides an apparatus, and an associated method, by which to facilitate clearance of vehicles at a border-crossing, or other checkpoint.

Through operation of an embodiment of the present invention, a manner is provided by which to document the occupants of the vehicle who provide information and an image taken within the vehicle to verify their identity and number.

In one aspect of the present invention, improved, and quicker authorization is provided to permit passage of a vehicle through the checkpoint or to alert checkpoint personnel of reporting anomalies. When an anomaly is reported, additional investigation of the vehicle is undertaken.

In another aspect of the present invention, a portable detector is provided that is positionable at the border-crossing or other checkpoint. When a vehicle is positioned at the checkpoint, a vehicular passenger, such as the operator of the vehicle, retrieves, or is otherwise provided with, the detector. The detector is used pursuant to self-reporting. That is to say, the detector is operated by one whose identity is to be documented. The device is analogously also operable, if desired, by checkpoint, or other, personnel. Entered information and an image within the vehicle is provided, and responsive to which decision is made, to permit the vehicle to pass through the checkpoint or to undergo further inspection.

In another aspect of the present invention, the device comprises, or includes, an apparatus that has an occupant-count gatherer that gathers information associated with the occupants of the vehicle stopped at the checkpoint. As self-reporting of information is utilized, the gatherer includes input transducers that transduce user-provided information.

In another aspect of the present invention, the input information that is gathered includes occupant fingerprints, and the gatherer includes a fingerprint reader that reads the fingerprints of the occupants of the vehicle. The fingerprint reader converts fingerprint information into electrical form when the fingerprint is read by the fingerprint reader.

In another aspect of the present invention, passport information of the occupants is also gathered. The gatherer includes a passport reader that reads passport information displayed on, or is otherwise provided by, a conventional passport. The passport information, when read, is converted into electrical form. Depending upon the type of passport reader, textual information, coded information, and the passport photo of the passport are all readable.

In another aspect of the present invention, an image capturer is further provided. The image capturer operates to generate image information within the vehicle, such as within the passenger compartment of an automotive vehicle. The image capturer is, e.g., an infrared (IR) camera that captures infrared-energy images. The infrared images provide color, or other, patterns that differ depending upon detected heat energy. The infrared image information provides identification of the number of occupants in the vehicle. Or, the image capturer comprises a conventional, photographic image in which the occupants of the vehicle are all included in the recorded images. Human, or other, viewing of the recorded images formed of the image information provides a count of the number of occupants of the vehicle.

In another aspect of the present invention, a user interface is provided to permit entry of information and display of information used and provided pursuant to operation. A keypad having one or more key actuators. And, the display device comprises, e.g., a liquid crystal display (LCD) or other video display, capable at least of displaying textual information. The display is also capable, e.g., a captured image captured by an image capturer.

In another aspect of the present invention, gathered input information and captured image information, once gathered, created, and converted into electrical form, is provided to an analyzer. The analyzer is, e.g., positioned remote from the device, and connected thereto by way of a wired or wireless connection. The analyzer analyzes the provided input information and the provided image information. Responsive to the analysis, a determination is made as to whether to permit passage of the vehicle through the checkpoint or to elect to require the vehicle, and the occupants therein, to undergo additional inspection.

In another aspect of the present invention, the analyzer includes an image analyzer that analyzes the captured image information. Through analysis of the image, a count is provided of the number of occupants in the vehicle. The image analysis and count is, e.g., automatically performed at the analyzer, or, alternately, the images are manually viewed and the count is manually obtained.

In another aspect of the present invention, once a count of the number of occupants of the vehicle is obtained through analysis of the captured image information, a comparison of the counted number of occupants is made with the number of occupants identified in the vehicle through the gathered information. A comparator indicates whether the number of occupants counted in the count of the image information corresponds, i.e., is equal to, the number of occupants identified by the input information entered by the occupants of the vehicle. If the values correspond, the self-reported input information corresponds to the captured-image information count. If, conversely, the counts are dissimilar, further inspection of the vehicle is warranted.

In these and other aspects, therefore, an apparatus, and an associated method, is provided for facilitating documentation of occupants of a vehicle at a vehicular checkpoint. An occupant-count gatherer is configured to gather input information of each occupant of the vehicle. An image capturer is configured to record image information within the vehicle that includes all of the occupants of the vehicle. The image information is comparable with the input information gathered by the occupant count gatherer.

A more complete appreciation of the scope of the present invention and the manner in which it achieves the above-noted and other improvements can be obtained by reference to the following detailed description of presently-preferred embodiments taken in connection with the accompanying drawings that are briefly summarized below, and by reference to the appended claims.

### BRIEF DESCRIPTION OF THE DRAWINGS

FIG. 1 illustrates a functional block diagram of a vehicular checkpoint at which an embodiment of the present invention is operable.

FIG. 2 illustrates a functional block diagram of a documentation device of an embodiment of the present invention.

FIG. 3 illustrates a functional block diagram of an analysis station of an embodiment of the present invention.

FIG. 4 illustrates a process diagram representative of the process of operation of an embodiment of the present invention.

FIG. 5 illustrates a process diagram also representative of operation of an embodiment of the present invention.

FIG. 6 illustrates a method flow diagram representative of the method of operation of an embodiment of the present invention.

### DETAILED DESCRIPTION

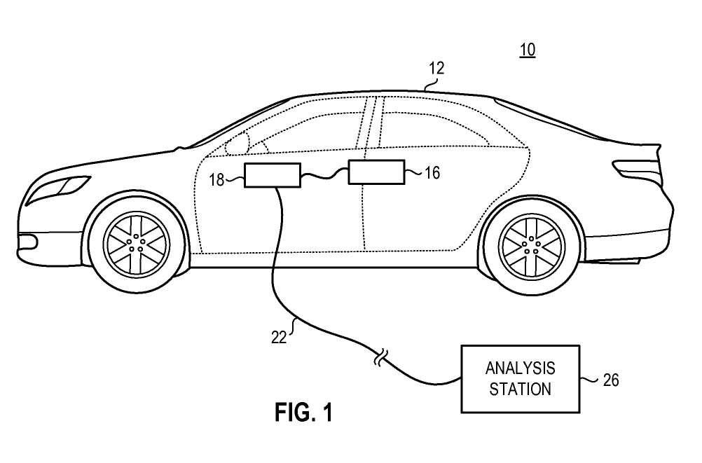

Referring first to FIG. 1, a vehicular checkpoint, shown generally at 10, is representative of, e.g., a border-crossing or any other stopping point at which one attempting to pass through the checkpoint must be documented or otherwise authorized prior to passing beyond the checkpoint. As mentioned previously, manning of a border-crossing, or other checkpoint, often times requires significant numbers of personnel. And, even when the checkpoint is adequately manned, long queues form at the checkpoint, resulting in significant delays for those attempting to pass through the checkpoint.

Typically, a significant majority of those wanting to pass through the checkpoint have proper documentation and, upon review of the documentation are permitted passage beyond the checkpoint. And, typically, only a small number of those attempting to pass through the checkpoint do not have proper documentation or otherwise are not permitted to pass through the checkpoint. But, in order to ensure that only those authorized to pass through the checkpoint are actually granted permission to pass, the checkpoint personnel must document everyone attempting to pass through the checkpoint.

The checkpoint 10 illustrated in FIG. 1 operates in conjunction with an embodiment of the present invention to facilitate documentation of occupants of a vehicle, such as the vehicle 12, at a border-crossing or other checkpoint. While the following description shall describe exemplary operation in which the checkpoint forms a vehicular border-crossing, in other implementations, various embodiments of the present invention are implementable at other types of checkpoints, including non-vehicular checkpoints.

Here, a portable documentation device 16 of an embodiment of the present invention is positioned in proximity to the vehicle 12 when the vehicle 12 stops at the checkpoint. The device 16 is here holstered at a device support 18. When the vehicle arrives at the checkpoint, the vehicle is positioned in proximity to the device support at which the device 16 is holstered. The driver, or other occupant of the vehicle, retrieves the device 16 from the device support.

The device, as shall be described more fully with respect to subsequent figures, provides for the entry of documentation and substantiation information to document and to evidence the occupants of the vehicle 12 that desire passage through the checkpoint 10. When all the occupants have provided documentation information and substantiation evidence has been created, the device 16 is returned to the device support and holstered thereat. The documentation and substantiation information is provided, here represented by way of the path 22, to an analysis station 26. In one implementation, the path 22 comprises a wired path; in another implementation, the path comprises a wireless connection; in another implementation, the path comprises both a wired and wireless connection portions. In one implementation, a wireless connection is formable between local transceiver elements positioned at the device 16 and the device support 18, and a wired connection is formed between the transceiver at the device support and the analysis station. By using the wireless connection, a user of the device 16 is able to cause transmission of the gathered documentation and substantiation information by way of the wireless link and the wired connection to the analysis station as soon as the information has been entered.

When the information is delivered to the analysis station, its contents are detected and analyzed. The documentation information is verified, such as through comparison or authentication with stored contents at a database repository (not shown). The documentation information comprises information sets associated with each occupant of the vehicle. Analysis of the documentation information also provides a count of the number of occupants of the vehicle. The substantiation information evidences the number of occupants of the vehicle. The number of occupants, evidenced by the substantiation information is compared with the number of the occupants identified through analysis of the documentation information. And, e.g., the number of information sets defines a count whose value is compared with the number evidenced by the substantiation information. A determination is made as to whether the counts correspond. If the occupant-count corresponds, and the documentation information is otherwise considered to be valid and permitting of the occupants to pass through the checkpoint, a grant of passage is approved, or given consideration for approval. If, conversely, the occupant-count values differ, additional inspection of the vehicle and its occupants is warranted. Denial of passage or instructions to checkpoint personnel to inspect further the vehicle occurs instead.

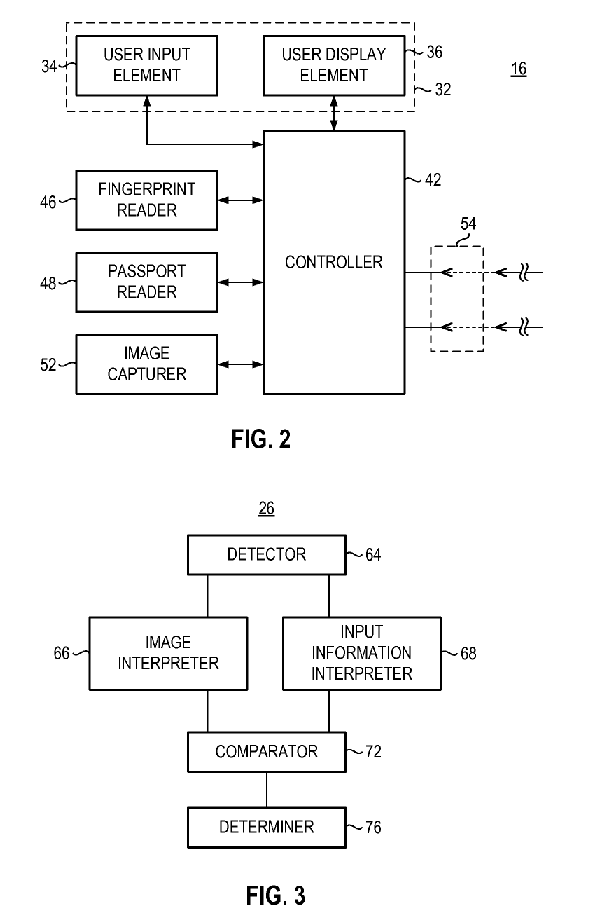

FIG. 2 illustrates elements of the documentation device 16 that is used pursuant to documentation of occupants of a vehicle that is requesting passage through a checkpoint, such as a border-crossing point. The elements of the device are functionally represented, implementable in desired manner, including algorithms executable by processing circuitry. In the exemplary implementation, the device 16 forms a portable device, and all of the elements are supported at, or within, a device housing. In other implementations, elements of the device are distributed at more than one physical entity.

The device forms an apparatus that includes a user interface 32 that includes a user input element 34 and a user display element 36. The user input element comprises, for instance, one or more input actuation keys that a user of the device is able to actuate pursuant to device operation, e.g., to initiate operation and to provide various inputs during operation of the device. The user display element comprises, for instance, a liquid crystal display that is capable of displaying textual data and images.

The input element and the display element 34 and 36 are coupled to a controller 42. The controller comprises, for instance, a processing device and associated circuitry, and is operable to control operation of the device 16. The controller receives inputs entered by way of the user input element 34. And, the controller also controls displays that are displayed at the user display element.

The device also includes, here a fingerprint reader 46 and a passport reader 48. Both of the information-gathering elements 46 and 48 are also coupled to the controller 42. Information gathered by the elements 46 and 48 is provided to the controller, such as at a memory element (not separately shown) thereof, during operation of the device. The controller also provides control information to the elements 46 and 48 to control their operation.

The device 16 further includes an image capturer 52. The image capturer comprises, in one exemplary implementation, an infrared (IR) sensor that senses infrared energy. In another exemplary implementation, the images capturer comprises a conventional camera that forms a conventional, photographic image. A captured image, whether in infrared, conventional photographic, or other form, is provided to the controller and, e.g., stored at a memory element of the controller. The controller also operates to control operation of the image capturer. In the exemplary implementation, successive images are automatically made while the device 16 is used to input the documentation information. And, images are also made responsive to manual actuation.

The device further includes a connector element 54 that provides for interconnection of the device with an external element, such as the path 22 (shown in FIG. 1) that extends to the analysis station 26 (also shown in FIG. 1).

In exemplary operation, the device operates to document occupants of a vehicle stopped at a border-crossing or other vehicular checkpoint. An occupant of the vehicle retrieves the device and initiates operation, such as through actuation of a key of the user input element 34. Responsive to initiation, a display is displayed on the user display providing instructions for use. First, an occupant of the vehicle is prompted to provide fingerprint information to the fingerprint reader 46. Fingerprint information is provided, e.g., by the occupant placing the occupant's finger or thumb at the fingerprint reader. Once the fingerprint information is correctly entered, the occupant is prompted to provide passport information to the passport reader. The passport reader, e.g., forms a scanner that scans passport information of a passport.

Once the occupant has successfully provided fingerprint information and passport information, the occupant is prompted to identify whether an additional occupant is in the vehicle that should provide documentation information. The input information associated with the occupant comprises and information set. An answer to the prompt is entered by way of the user input element 34. If an additional occupant remains to provide the documentation information, the additional occupant provides fingerprint information and passport information by way of the elements 46 and 48. The input information of this additional occupant also comprises an information set. Once successfully entered, prompt is again made to inquire whether an additional occupant remains in the vehicle that should provide documentation information. If so, then the additional occupants follow the same procedure by which to provide documentation information.

When no occupants in the vehicle remain that need to provide documentation information, a prompt is generated to prompt an occupant of the vehicle to use the device to capture, by way of the image capturer 52, an image of all of the occupants within the vehicle. The image capturer includes a lens or is otherwise capable of forming a wide-angled image that encompasses all of the interior of the vehicle. Once captured, the image is displayed on the user display to permit an occupant of the vehicle to confirm that the image is acceptable. Acceptance of the image is also indicated through entry by way of the user input element. Once the gathered information, gathered by way of the elements 46 and 48 and the substantiation information, i.e., the image captured by the image capturer has been entered, the controller causes generation of a display on the user display to prompt return of the device to the device support 18 (shown in FIG. 1) or otherwise to cause sending of the entered information to the analysis station 26.

FIG. 3 illustrates the elements of the analysis station 26. The elements are also functionally represented, implementable in any desired manner. In the exemplary implementation, the elements of the analysis station are embodied at a single physical location. In other implementations, the elements are distributed across more than one physical entity. The analysis station is, e.g., positioned at a checkpoint control center that oversees the operation of the checkpoint.

The analysis station includes a detector 64, an image interpreter 66, an input information interpreter 68, a comparator 72, and a determiner 76.

The detector 64 operates to detect the documentation and substantiation information provided by the device 16 (shown in FIGS. 1-2) by way of the path 22 (shown in FIG. 1). Detected documentation information is provided to the input information interpreter 68, and detected substantiation information is provided to the image interpreter 66.

The image interpreter, once provided with the substantiation information, i.e., the image information associated with the captured images, both those automatically captured and that captured responsive to manual actuation, functions as a counter to count the number of occupants of the vehicle, identified in the captured image. In an implementation in which the captured image information comprises an infrared image, the count is based upon the areas of the image that identify elevated temperature levels. If the captured image information comprises a conventional photographic image information, the count is based upon the number of occupants identified in the photographs. In one implementation, the image information of the successive images, both automatically and manually captured, is compared to obtain the count. The input information interpreter also provides a count of the number of occupants of the vehicle. The numbers of passports that are read, the numbers of fingerprints that are read, etc. all identify the number of occupants of the vehicle to obtain the count.

Counts obtained by the image interpreter 66 and by the input information interpreter 68 are provided to the comparator 72. The comparator compares the values of the counts provided by the elements 66 and 68. And, results of the comparison made by the comparator are provided to the determiner 76. If the comparison made by the comparator indicates that the counts correspond, the count is documented and the provided information is of increased believability. Conversely, if the results of the comparison indicate count dissimilarities, a determination is made by the determiner that the provided information is suspect. And, further inspection of the vehicle is warranted. An alert, e.g., is generated to alert personnel of the checkpoint to perform the further inspection.

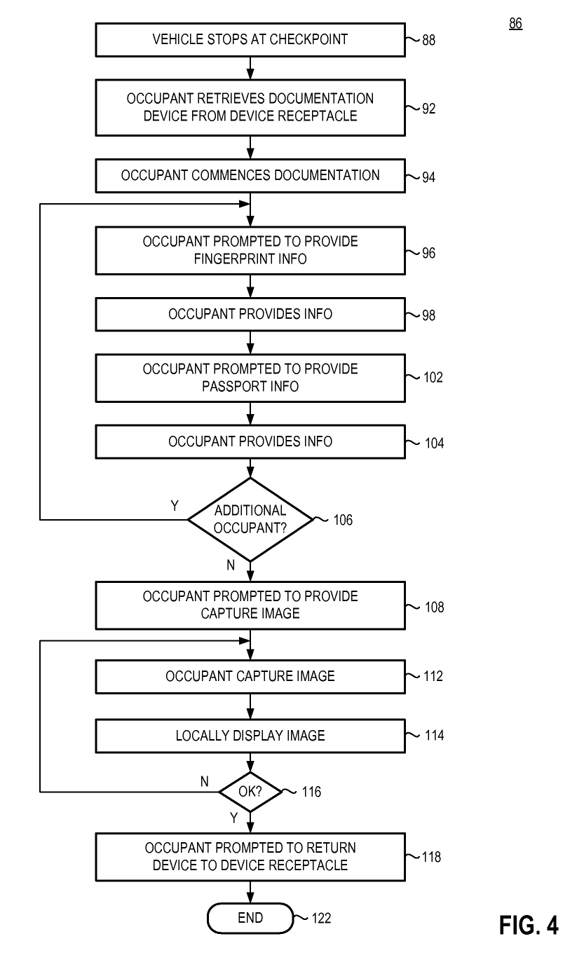

FIG. 4 illustrates a process, shown generally at 86, representative of exemplary operation of an embodiment of the present invention. The process facilitates self-reporting of occupants of a vehicle stopped at a border-crossing, or other checkpoint.

First, and as indicated by the block 88, a vehicle stops at the checkpoint. Then, and as indicated by the block 92, an occupant of the vehicle retrieves a documentation device from a documentation-device receptacle. And, as indicated by the block 94, the occupant commences documentation procedures by which the occupants of the vehicle are documented in order to grant their permission to pass through the checkpoint.

A first occupant of the vehicle is prompted, as indicated by the block 96, to provide fingerprint information. And, in response, as indicated by the block 98, the occupant provides fingerprint information. Then, as indicated by the block 102, the occupant is prompted to provide passport information. And, as indicated by the block 104, the occupant provides the passport information. Once the fingerprint and passport information, viz., the documentation information, is successfully provided by the occupant, a determination is made, as indicated by the decision block 106 as to whether an additional occupant of the vehicle remains to submit documentation information. If so, the yes branch is taken back to the block 96. If, conversely, no additional occupants remain to submit documentation information, the no branch is taken to the block 108.

At the block 108, the occupant is prompted to capture, i.e., record, an image within the vehicle. This image is, e.g., in addition to images that are automatically captured. And, as indicated by the block 112, the occupant captures an image within the vehicle. The captured image is displayed locally, as indicated by the block 114. And, a determination is made, indicated by the decision block 116 as to whether the captured image is adequate, i.e., includes all of the occupants of the vehicle. If not, the no branch is taken back to the block 108. Otherwise, the yes branch is taken to the block 118. At the block 118, an occupant of the vehicle is prompted to return the documentation device to a device receptacle. And, the process ends, indicated by the block 122.

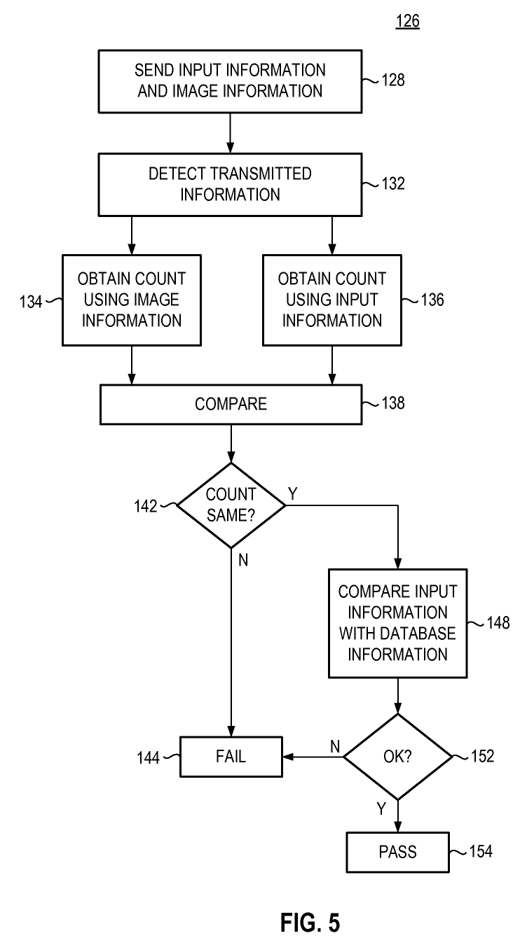

FIG. 5 illustrates a process, shown generally at 126, representative of operation of an embodiment of the present invention. The process facilitates documentation of the occupants of a vehicle. First, and as indicated by the block 128, documentation information and substantiation information is sent to an analysis station. And, the information is detected, indicated by the block 132.

The detected information is analyzed, here to obtain a first count, indicated at the block 134 and to obtain a second count, indicated by the block 136 representative of the number of occupants in a vehicle that is requesting passage through the checkpoint. The first count is obtained through analysis of substantiation information, and the second count is obtained through analysis of documentation information.

Once the counts are obtained, the counts are compared, indicated by the block 138. Then, as indicated by the decision block 142, a determination is made as to whether the counts correspond. If the counts do not correspond, the inspection is reported as a failure, indicated by the block 144. If, conversely, the counts correspond, the yes branch is taken to the block 148. At the block 148, comparison of the documentation information is made with database-stored information. A determination is made, indicated by the decision block 152, as to whether the database-stored information corresponds with the documentation information. If so, the yes branch is taken to the block 154, and the inspection is reported as a passed inspection. Otherwise, the no branch is taken to the block 144, and the inspection is reported as a failed inspection.

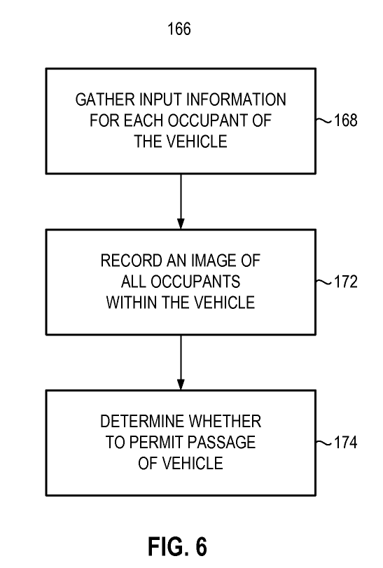

FIG. 6 illustrates a method flow diagram, shown generally at 166, representative of the method of operation of an embodiment of the present invention. The method facilitates documentation of occupants of a vehicle at a vehicular checkpoint.

First, and as indicated by the block 168, input information of each occupant of the vehicle is gathered. Then, and as indicated by the block 172, an image within the vehicle that includes all of the occupants of the vehicle is recorded.

Then, and as indicated by the block 174, a determination is made whether to permit passage of the vehicle beyond the checkpoint responsive to the input information and the image.

A manner is thereby provided by which to document the occupants of the vehicle. Self-reporting is utilized, but verified, through use of substantiation information that is compared together with documentation information. Checkpoint verification, using fewer checkpoint personnel, is facilitated.

Presently preferred embodiments of the invention and many of its improvements and advantages have been described with a degree of particularity. The description is of preferred examples of implementing the invention and the description of preferred examples is not necessarily intended to limit the scope of the invention. The scope of the invention is defined by the following claims.

What is claimed is:

1. An apparatus for facilitating documentation of occupants of a vehicle at a vehicular checkpoint, said apparatus comprising:
an occupant-count gatherer configured to gather input information of each occupant of the vehicle; and
an image capturer configured to record an image within the vehicle that includes all of the occupants of the vehicle, the image comparable with the input information gathered by said occupant count gatherer.

2. The apparatus of claim 1 wherein said occupant-count gatherer is further configured to gather occupant-provided information.

3. The apparatus of claim 1 wherein said occupant-count gatherer is further configured to gather occupant biometric information.

4. The apparatus of claim 1 wherein said occupant-count gatherer comprises a fingerprint scanner configured to scan fingerprints of the occupants.

5. The apparatus of claim 1 wherein said occupant-count gatherer comprises an identification card scanner configured to scan identification card information, the identification confirmation scanned there from comprising the input information.

6. The apparatus of claim 5 wherein the identification card comprises photographic information, wherein the information scanned from the identification card comprises the photographic information, and wherein the photographic information, once scanned, comprises the input information.

7. The apparatus of claim 1 wherein said occupant-count gatherer comprises a passport reader and wherein the input information comprises vehicular-occupant passport information read by said passport reader.

8. The apparition of claim 1 further comprising a user interface including an input actuator, of which actuation thereof causes operation of said occupant-count gatherer.

9. The apparatus of claim 1 further comprising a user interface including a user display, said user display configured to display a representation of the image recorded by said image capturer.

10. The apparatus of claim 1 wherein said image capturer comprises an infrared scanner.

11. The apparatus of claim 1 wherein said image capturer comprises a camera.

12. The apparatus of claim 1 further comprising an interface connects configured to form an external connection at which the input information and a representation of the image are provided.

13. A method for facilitating documentation of occupants of a vehicle at a vehicular checkpoint, said method comprising:
gathering input information of each occupant of the vehicle; and
recording an image within the vehicle that includes all of the occupants of the vehicle, the image comparable with the input information gathered during said gathering.

14. The method of claim 13 wherein said gathering comprises gathering fingerprint information of each occupant of the vehicle.

15. The method of claim 13 wherein said gathering comprises gathering passport information of each occupant of the vehicle.

16. The method of claim 13 further comprising:
comparing determining whether to permit passage of the vehicle beyond the checkpoint responsive to the input information and the image.

17. The method of claim 16 wherein the vehicle is permitted passage beyond the checkpoint when the input information corresponds to the image.

18. The method of claim 17 further comprising:
determining how many occupants are identified by the input information to be in the vehicle; and
determining how many occupants are identified by the image to be in the vehicle.

19. The method of claim 18 wherein the vehicle is permitted passage when the occupants identified to be in the vehicle by the input information correspond in number with the occupants identified by the image to be in the vehicle.

20. An apparatus for facilitating documentation of vehicular-positioned occupants of a vehicle, said apparatus comprising:
a detector configured to detect an indication of input information of the occupants of the vehicles and an indication of a scanned image inside the vehicle;
a determiner configured separately to identify how many occupants are in the vehicle based upon the indication of the input information and to identify how many occupants are in the vehicle based upon the indication of the scanned image; and
an alerter configured to generate an alert if the separate identifications made by said determiner are dissimilar.
